(19) United States
(12) Patent Application Publication
(10) Pub. No.: US 2008/0073913 A1
(43) Pub. Date: Mar. 27, 2008

(54) Panel Fastener

(76) Inventor: Xinhu Gu, Ningbo (CN)

Correspondence Address: GLOBAL IP SERVICES, 7285 W. Eagle Court, Winton, CA, 95388, US

(21) Appl. No.: 11/618,988

(22) Filed: Jan. 2, 2007

(30) Foreign Application Priority Data
Sep. 27, 2006 (CN) 200610053620.7

(51) Int. Cl. E05C 5/00

(52) U.S. Cl. 292/65

(57) ABSTRACT

A panel fastener comprises casing 1 and casing 2 in lathing engagement. In casing 1, there is mounted a hook with a hook-shaped head and a ring-shaped tail. In the ring-shaped tail, there is mounted an eccentric cam which is interlocked with the inner wall of the hook by a spring tab. The hook is rotary and built into casing 1 with the inner hexagon eccentric shaft. Correspondingly, there is a fixed axis mounted in the casing 2. It features that the said eccentric cam and its eccentric shaft are both made of steel material and that the eccentric shaft is inserted into the connecting hole of the eccentric cam and welded with it together. In that way, the whole structure is suitable for application on panel fasteners with a solid cam, reliable performance, greater locking force and longer service life.

### CROSS REFERENCE TO THE RELATED PATENT APPLICATION

This application claims the priority of the Chinese patent application No. 200610053620.7, filed on Sep. 27, 2006.

### FIELD OF THE INVENTION

The present invention relates generally to a kind of fasteners, and particularly to panel fasteners for moveable panels fastened together to form portable cooler room.

### BACKGROUND OF INVENTION

Current portable cooler rooms are formed by moveable panels interlocked together by an eccentric fastener. So the key point to hold the room temperature is the drawing force of fasteners. Current panel fasteners comprise a nail-in-place lathe and a fixed axis. As shown in FIG. 1, a hook 3 comprises a hook-shaped head and a ring-shaped tail 4. In the ring-shaped tail 4, there is mounted an eccentric cam 6 made of zinc alloy which is interlocked with the inner wall of the hook 3 by a spring tab 7. A hexagon eccentric shaft 5 is made into an organic whole with the eccentric cam 6. An assembly of the eccentric cam 6, the spring tab 7 and the hook 3 is installed into the casing 1 with the eccentric shaft 5 passing through its two walls for easy operation. A fixed axis 9 is mounted in casing 2 for lathing engagement with the hook-shaped head of the hook 3. The said casing 1 and casing 2 are respectively mounted into matching positions on adjacent panels. Turn hexagon wrench already inserted into the eccentric shaft 5 to drive the eccentric cam 6 to rotate. Then the interlocked tab will consequently drive the hook 3 to rotate and catch the fixed axis 9. Continue turning the eccentric shaft 5 and produce an eccentric force thanks to the eccentric interlocking between the eccentric shaft 5 and walls of hook tail 4. This force will drive the hook 3 to move in parallel and self lock. And the hook head will draw the fixed axis to hold adjacent panels interlocked together. However, the said structure is found to have following defects during application: the zinc alloy die cast cam has a short service life since it is liable to crack under stress due to its poriness in structure. Moreover, the eccentric cam becomes dislodged from the hook easily due to the large gap between them and unreasonable design of the spring tab and thus results in fastener malfunctioning. After a period of use, the elastic distortion of the spring tab will certainly affect the interlock between the eccentric cam and the hook and consequently fail the fastener.

### SUMMARY OF THE INVENTION

The technical problem that this present invention seeks to solve is to provide a panel fastener with a solid eccentric cam and greater locking force, reliable performance, longer service life.

To solve the said technical problem, this present invention adopts the following proposal: a panel fastener comprises casing 1 and casing 2 in lathing engagement. In casing 1, there is mounted a hook with a hook-shaped head and a ring-shaped tail. In the ring-shaped tail, there is mounted an eccentric cam, which is interlocked with the inner wall of the hook by a spring tab. The hook is rotary and built into casing 1 with the inner hexagon eccentric shaft. Correspondingly, there is a fixed axis mounted in the casing 2. It features that the said eccentric cam and its eccentric shaft are both made of steel material and that the eccentric shaft is inserted into a connecting hole of the eccentric cam and welded together.

As improvement, at the two ends of the spring tab, there is respectively a notch whose width is mated with thickness of the eccentric cam and thus the spring tab is embedded with the eccentric cam on its two gaps. An arc-shaped back of the spring tab projects on its two sides and dents in middle. For the width of the dented portion is mated with the thickness of ring-shaped tail of the hook, the hook tail is secured in the dented portion of the spring tab. And thus the eccentric cam can be more steadily interlocked with the hook through the spring tab free of swinging and spreading, bringing about more reliable functioning of fastener.

As further improvement, there are projecting keys on the side face of the said eccentric shaft and correspondingly seats in the connecting hole of the eccentric cam for keys to insert in. The 2 projecting keys, in optimized number, spread symmetrically on the side face of the eccentric shaft. In that way, the bonding strength between the eccentric cam and shaft is got increased. Even if the welded connection between them breaks down, the eccentric cam and the shaft still can work for a period depending upon their connection via projecting keys and seats.

There are locating dowels, which are mated with lip in the casing 1, respectively fixed on the two sides of gap in the eccentric cam. It is helpful for positioning during manufacture and use.

As improvement, the eccentric shaft, with clamping pieces on its two ends, is mounted in rotatable mood into the casing 1 via a eccentric shaft hole stamped in the side panel of the casing 1 thus bringing about easy rotation of the shaft and also easy manufacturing.

As improvement, there is a locating slot in the backside of the hook and correspondingly a projecting locating piece, mated with the slot, stamped on the side panel of the casing 1 thus resulting in easy manufacturing and application.

As improvement, there are connecting holes and connecting sleeves stamped on the side panels of the casing 1 and the casing 2. The sleeves insert into the holes and then they are riveted together for easy manufacturing.

Last but not least, the space between the supporting part in the middle of two gaps and the inner wall of the hook tail is matched with thickness of the spring tab. In that way, even if it looses its elasticity after a long period of use, the spring tab will always keep in touch with the supporting part and the inner wall of the hook and thus work reliably.

Compared with the current technology, the present invention enjoys the following advantages: since the eccentric cam and hook assembly are both made of steel material without die casting, the fastener can be used with greater locking force and longer service life and free of cracking defect due to poriness. Its unique spring tab design brings about more steady and reliable engagement between the eccentric cam and the hook without loosening and spreading. The invention is reasonable in overall structure, easy in manufacturing and assembling and longer in its service life. Moreover, the cost and energy consumption are greatly reduced since the invention adopts steel material instead of relatively rare zinc alloy.

### BRIEF DESCRIPTION OF THE DRAWINGS

FIG. 1 Structure drawing of traditional panel fasteners.

FIG. 2 Structure drawing of this invention.

FIG. 3 free space exploded diagram of casing 1 of this invention.

FIG. 4 free space exploded diagram of casing 2 of this invention.

FIG. 5 free space diagram of the spring tab of this invention.

FIG. 6 Free space abridged general view 1 for this invention in use.

FIG. 7 Free space abridged general view 2 for this invention in use.

FIG. 8 Free space abridged general view 3 for this invention in use.

FIG. 9 Free space abridged general view 4 for this invention in use.

### DETAILED DESCRIPTION FOR THE INVENTION

The detailed description of this invention according to attached figures is as follows:

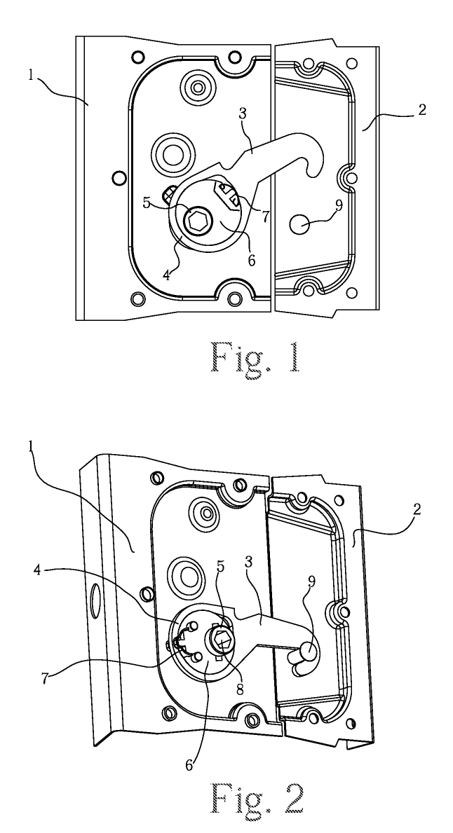

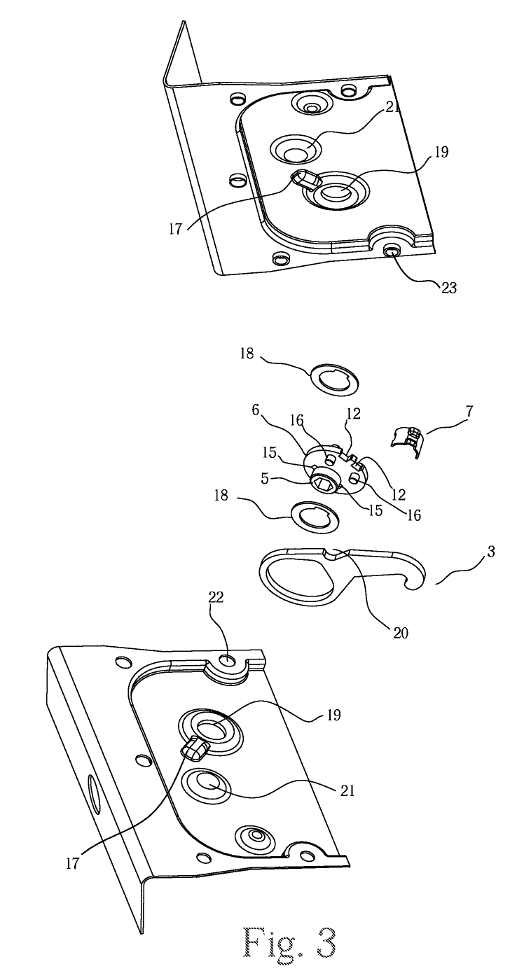

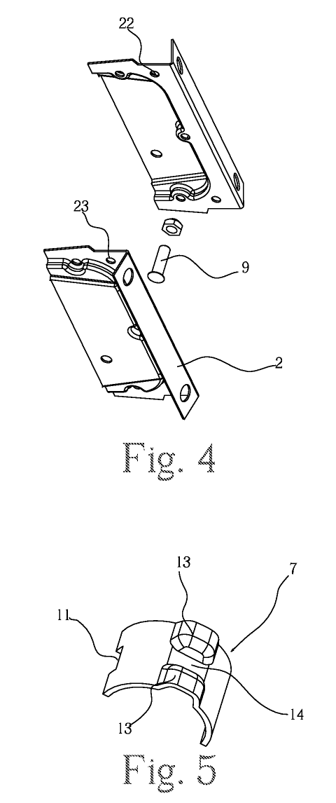

As shown in FIG. 2-5, a panel fastener comprises casing 1 and casing 2 fitted with each other. The metal shell of casing 1 is composed of 2 side panels with connecting holes 22 and sleeves 23 stamped on edges of side panels such as top side, bottom side and left side. Sleeves 23 on one side panel insert into holes 22 on the other side panel and they are riveted together to form the casing 1 with its cavity for installation. In casing 1, there is mounted a rotary hook 3 made of steel plate and consisting of a hook-shaped head and a ring-shaped tail 4. Within the said ring-shaped tail, there is an eccentric cam 6 with an eccentric shaft 5. 2 projecting keys 15 spread symmetrically on the sides of the shaft. Both the eccentric cam 6 and the eccentric shaft 5 are made of steel material, of which the eccentric cam 6 is stamped from a steel plate with a connecting hole in its center. Seats are stamped in the connecting hole of the eccentric cam 6 for keys to insert in. In that way, the eccentric shaft 5 is inserted into the eccentric cam 6 and welded together. The end of the eccentric shaft 5 is inner hexagon shaped to match with the hexagon wrench. The eccentric cam 6 is interlocked with the inner wall of the hook 3 by a spring tab 7, which is designed into a uniquely new structure. The spring tab 7, arc-shaped on the whole, has notches 11 on its two ends, whose width is mated with thickness of the eccentric cam 6 and thus the spring tab 7 is embedded with the cam on its two gaps. The arc-shaped back of the spring tab 7 projects on its two sides and dents in middle. For the width of the dented portion 14 is mated with the thickness of ring-shaped tail 4 of the hook, the hook tail is secured in the dented portion 14 of the spring tab 7 between the two projected portions 13. Moreover, the inner sidewall of the dented portion 14 can press against the supporting part between gaps 12 thus to keep the spring tab 7 free of swinging. The space between the supporting part in the middle of two gaps 12 and the inner wall of the hook tail 4 is matched with thickness of the spring tab 7. In that way, even if it looses its elasticity after a long period of use, the spring tab 7 will always keep in touch with the supporting part and the inner wall of the hook and thus work reliably. There are locating dowels 16, which are mated with lip stamped in the side panel of casing 1, respectively fixed on the two sides of gaps in the eccentric cam 6. There is a locating slot 20 in the backside of the hook and correspondingly a cap-shaped projecting locating piece, mated with the slot, stamped on the side panel of the casing 1. The spring tab 7 and the eccentric cam 6 together with the eccentric shaft 5 are mounted in the ring-shaped tail 4. The eccentric shaft 5, with clamping pieces 18 on its two ends, is mounted in rotatable mood into the casing 1 via a shaft hole 19 stamped in the side panel of the casing 1.

In the same way, the metal shell of casing 2 is composed of 2 side panels with connecting holes 22 and sleeves 23 stamped on edges of side panels such as topside, bottom side and right side. Sleeves 23 on one side panel insert into holes 22 on the other side panel and they are riveted together to form the casing 2 with its cavity for installation of a fixed axis 9.

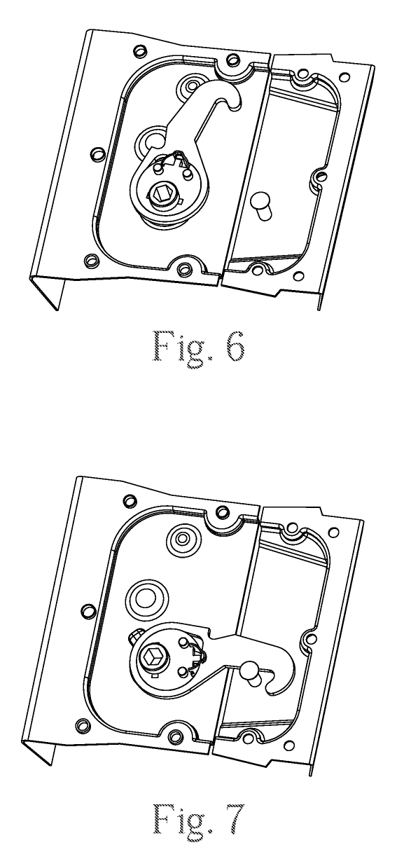

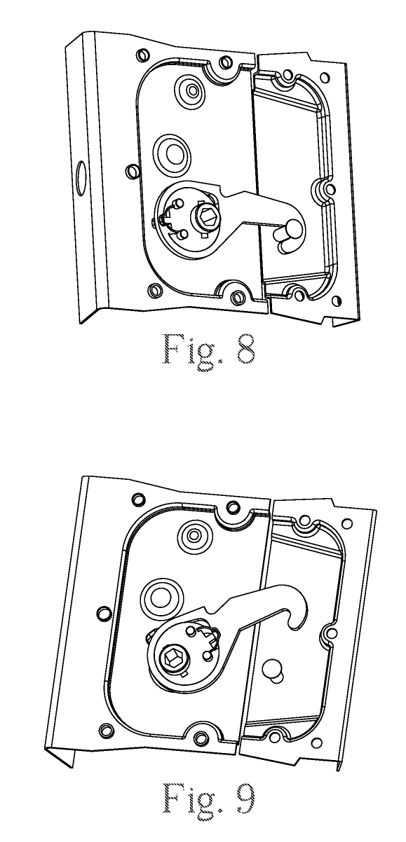

For operation, the said casing 1 and casing 2 are respectively mounted into matching positions on adjacent panels. Turn hexagon wrench inserted into the eccentric shaft 5 to drive it to rotate. As shown in FIG. 6, since the eccentric cam 6, together with the eccentric shaft 5, is interlocked with the hook 3 through the spring tab 7, the hook 3 can surely be driven to rotate and catch the steel fixed axis 9 in casing 2 with its hook-shaped head. As shown in FIG. 7, continue turning the eccentric shaft 5 and produce an eccentric force thanks to the eccentric interlocking between the eccentric shaft 5 and walls of hook tail 4. This force will drive the eccentric cam 6 to rotate against the hook 3 and thus the hook 3 will move parallelly toward casing 1 and self-lock. And the hook head will draw the fixed axis to hold adjacent panels interlocked together. As shown in FIG. 8, when unlocking, insert the hexagon wrench into the eccentric shaft 5 in casing 1 and rotate inversely the hexagon wrench to drive the shaft to rotate inversely. At beginning, the hook 3 cannot rotate with the eccentric shaft 5 and only make translation movement towards casing 2 since the hook head is caught with the steel-made fixed axis 9. After the hook head gets away from the fixed axis 9, the eccentric cam 6 together with the eccentric shaft 5 will be interlocked with the hook 3 with the help of spring tab 7 and make inverse rotation to unlock the fastener (See FIG. 9). When the hook 3 tries to continue rotating upward from the position shown in FIG. 9, the locating slot 20 in the backside of the hook 3 will be fastened with the locating piece in the casing 1 to stop its further rotating. In that way, adjacent panels forming the cooler room can be mounted and dismounted.

What is claimed is:

1. A panel fastener comprising:
a first casing and a second casing;
a hook having a hook-shaped head and a ring-shaped tail located in said first casing;
an eccentric cam interlocked with the inner wall of said hook by a spring tab located in said ring-shaped tail;
said hook being installed in said first casing in turnable by an eccentric shaft which has an inner polygon hole;
a fixed axis mounted in said second casing;
said eccentric cam (6) and said eccentric shaft being made of steel material, said eccentric shaft being inserted into a connecting hole of said eccentric cam and being welded therein.

2. The panel fastener of claim 1, wherein at the two ends of said spring tab possess a notch respectively, whose width is mated with the thickness of said eccentric cam and thus said spring tab is embedded with said eccentric cam on its two gaps; said spring tab has a dented portion on its back with a width mated with the thickness of the ring-shaped tail of said hook, the hook tail is secured in the dented portion of said spring tab between the two projected portions.

3. The panel fastener of claim 1, wherein there are projecting keys on said eccentric shaft (5) and correspondingly seats in a connecting hole of said eccentric cam for receiving the keys.

4. The panel fastener of claim 3, wherein there are two said projecting keys located on said eccentric shaft symmetrically.

5. The panel fastener of claim 4, wherein locating dowels mated with lip located in said first casing are fixed beside the gaps on said eccentric cam respectively.

6. The panel fastener of claim 5, wherein the eccentric shaft with clamping pieces located on its two ends are turnably mounted in a shaft hole located on the side panel of said first casing.

7. The panel fastener said of claim 6, wherein there is a locating slot in the backside of said hook, a projecting locating piece mated with the slot is on a side panel of said first casing.

8. The panel fastener of claim 7, wherein there are connecting holes and connecting sleeves on the panels of said first and second casings, the connecting Sleeves are inserted into the connecting holes for riveting two casings together.

9. The panel fastener of claim 8, wherein the space between a supporting part located in the middle of the two gaps and the inner wall of said hook tail (4) is matched with thickness of said spring tab.

10. The panel fastener of claim 2, wherein there are projecting keys on said eccentric shaft and correspondingly seats in a connecting hole of said eccentric cam for receiving keys.
